(19) United States
(12) Patent Application Publication
(10) Pub. No.: US 2014/0099817 A1
(43) Pub. Date: Apr. 10, 2014

(54) Tool Changer

(71) Applicant: DELAWARE CAPITAL FORMATION, INC., Wilmington, DE (US)

(72) Inventors: Maurice PERLMAN, Oak Park, MI (US); Kenneth Paul DELLACH, Shelby Township, MI (US)

(21) Appl. No.: 13/790,230

(22) Filed: Mar. 8, 2013

Related U.S. Application Data
(60) Provisional application No. 61/711,484, filed on Oct. 9, 2012.

(51) Int. Cl. H01R 13/62; H01R 13/64

(52) U.S. Cl. CPC H01R 13/62; H01R 13/64
USPC 439/357; 439/345

(57) ABSTRACT

A tool changer has a first and second member. The first and second members include first and second electrical connectors. The electrical connectors include elastomeric sheaths. The first and second members are locked together such that the first electrical connector is aligned with the second electrical connector so that upon contact, the sheaths deform to maintain electrical contact between the first and second electrical connectors.

### CROSS-REFERENCE TO RELATED APPLICATION

This application claims the benefit of U.S. Provisional Application No. 61/711,484, filed on Oct. 9, 2012. The entire disclosure of the above application is incorporated herein by reference.

### FIELD

The present disclosure relates to tool changers and, more particularly, to manual tool changers with automatic electrical connections.

### BACKGROUND

Tool changers are perfect for flexible or multiple robotic tooling applications that utilized only one robot. End effector tooling in modular fixtures can be changed quickly and easily to accommodate many different styles of parts on the same assembly machine or machining center. This enables the end effectors to be changed and swapped out very rapidly. Ordinarily, an electrical connection is mounted on the tool changers to provide an electrical connection between the tool changer parts. Mating electrical connectors can be of a pin and socket style where the pins or sockets are held in a rigid housing with the housings having inner mating guiding features to align the male and female halves of the connectors. Additionally, spring pins and pads may be utilized. Here, the spring pins come into connect with corresponding pads on the mating tool half. The spring force maintains the electrical contact between the two contacts. While these types of connectors are satisfactory, designers strive to improve the art.

The present disclosure provides the art with a manual tool changer that includes an automatic electrical contact connection. The connection provides a resilient contact that maintains contact between the contact faces. The resilient contact enables simple rigid mounting of the electric contacts to both halves of the tool changer. The present disclosure provides a simple molded construction to enable easy attachment to the tool changer halves. Additionally, the electric contacts accommodate for slight misalignments between the electrical contacts.

### SUMMARY

According to the disclosure, a tool changer comprises a first member and a second member. The first member has a body with a base to secure with a robot or the like. The body includes a receiving portion to receive an extending portion of the second member. An electrical connector is positioned on the first member body. The electrical connector includes an elastomeric sheath. The second member includes a body with a mechanism to receive an end effector. A second electrical connector is positioned on the second member body. An elastomeric sheath is positioned on the second electrical contact. A mechanism to lock the first and second members together is coupled with them. The locking mechanism couples the first and second members together such that the first electrical contact is aligned with the second electrical contact. Thus, upon contact and locking, the sheath deforms to maintain electrical contact between the first and second electrical contacts. One of the electrical connectors is male; the other female. One of the electrical contacts may have an overall conical shape. The contact surface of the first and second electrical contacts may be flat or slightly convex. The elastomeric sheath may be polyurethane. The first and second electrical contacts are resilient to enable compression and once the compression force is removed, the first and second electrical contacts return to their original condition.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of the tool changer with the tool halves locked together;

FIG. 2 is a perspective view of a first half of the tool changer;

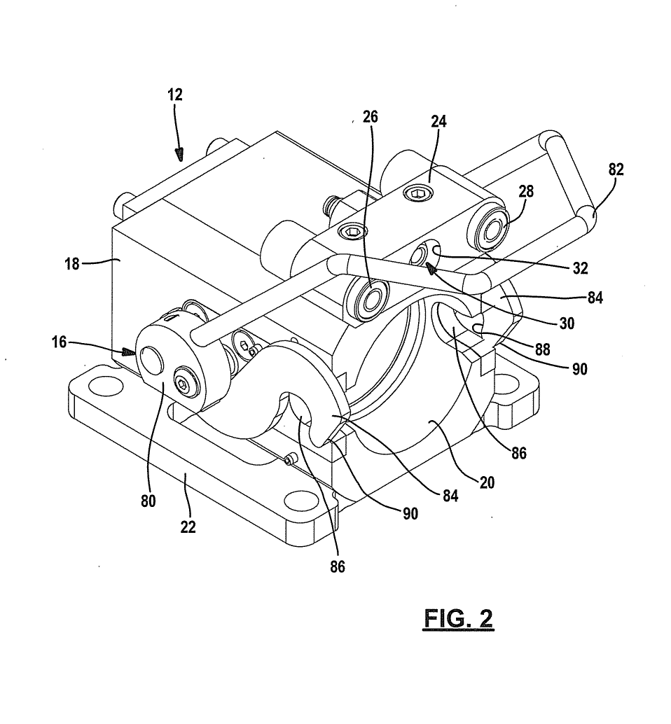

FIG. 3 is a perspective view of a second half of the tool changer;

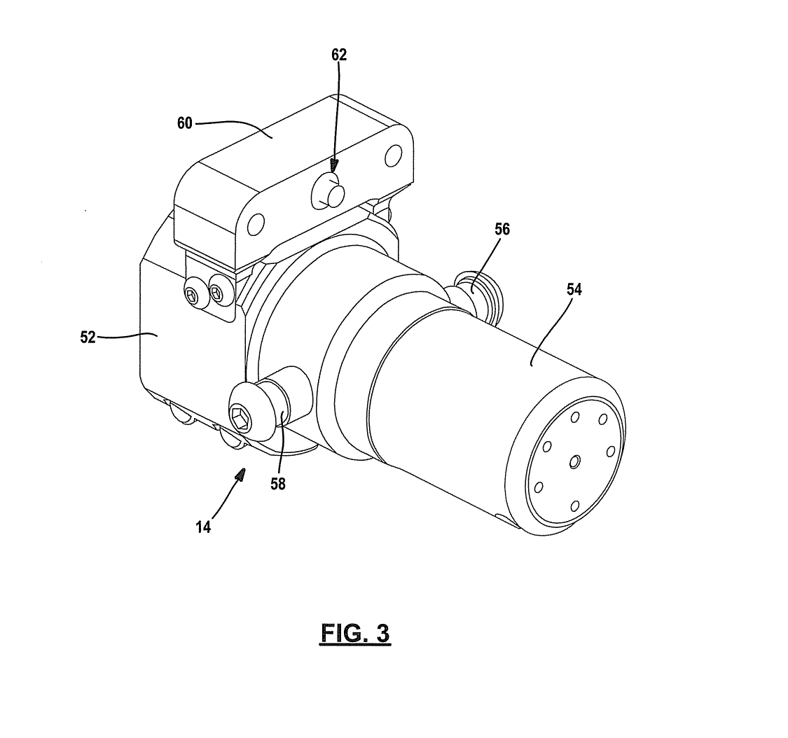

FIG. 4 is a schematic, partially in cross-section, top plan view of the electrical connectors;

FIG. 5 is a view like FIG. 4 with the electrical contact coupled to one another.

### DETAILED DESCRIPTION

Example embodiments will now be described more fully with reference to the accompanying drawings.

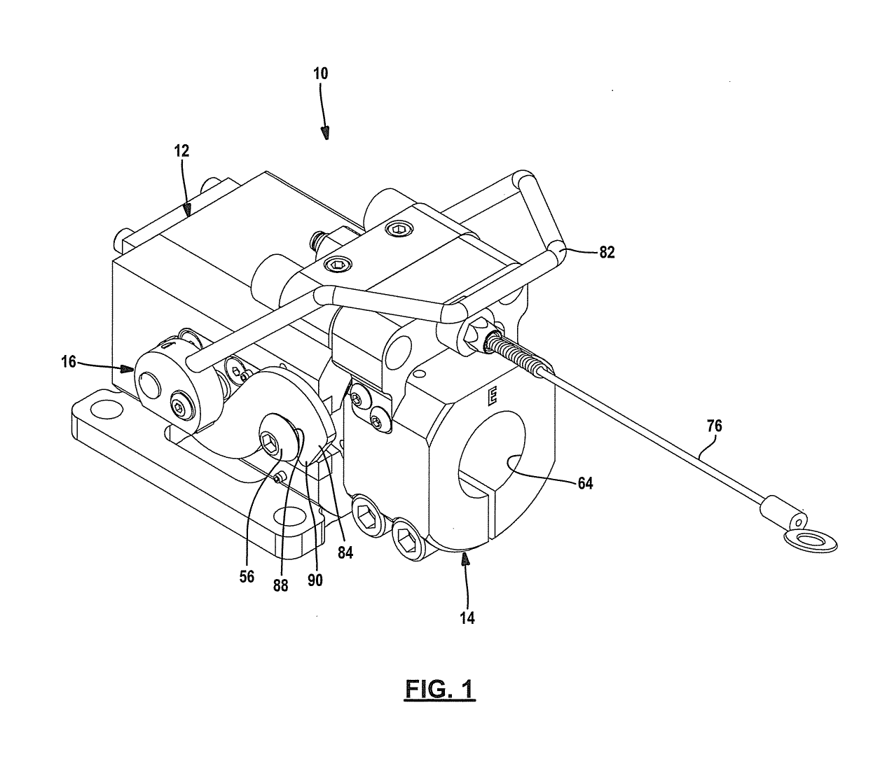

Turning to the figures, specifically FIG. 1, a manual tool changer is illustrated and designated with the reference numeral 10. The tool changer includes a first member or half 12 and a second member or half 14 and a locking mechanism 16 coupling the two halves 12, 14 together. The first member or half 12 includes a body portion 18. The body portion 18 has an overall rectangular cylindrical configuration. The body portion 18 includes a hollow receiving portion or bore 20. The receiving portion 20 is a bore in the body 18 that receives the second member 14. The body portion includes a base 22 to secure the body portion 18 with a robot, automation, or the like.

The body portion 18 includes a housing 24 positioned on a side of the body portion 18. The housing 24 houses the first electrical connector 30 as well as pneumatic hose connections 26, 28.

The electrical connector 30 is positioned in a bore 32 and is recessed in the bore 32. The electrical connector 30 includes an electrical contact 34 surrounded by an elastomeric sheath 36. The elastomeric sheath 36 may be manufactured from polyurethane or the like materials. The sheath 36 has a conical configuration 38 at the end of the electrical contact surface 40. The electrical contact surface 40 may be flat, slightly convex or the like to enhance electrical connection and transmission. The sheath 36 has a cylindrical portion 42 that surrounds and maintains the first connector 30 in the bore 32.

The second member or half 14 includes a body member 52. The body member 52 includes an extending cylindrical portion 54. The extending cylindrical portion 54 is received in the receiving portion or bore 20 of the first member 12. A pair of trunnions 56, 58 extends transversely to the extending cylindrical portion 54. A housing 60 is coupled with the body portion 52. The housing 60 includes the second electrical connector 62. Additionally, the body portion 52 includes a bore 64 that receives an end effector or the like.

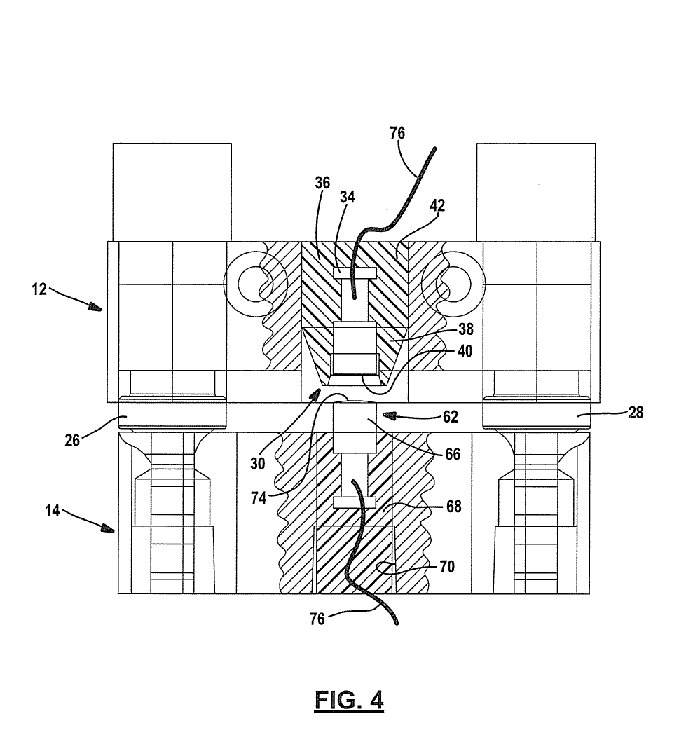

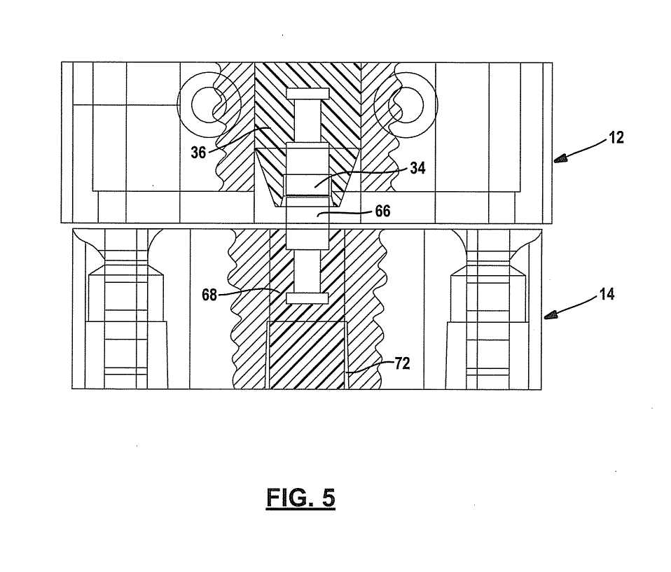

The electrical connector 62 includes an electrical contact 66 and a polymeric sheath 68. The electrical contact 66 is buried in the sheath 68. The sheath 68 may be formed from an elastomeric material such as polyurethane. The sheath 68 is positioned within a bore 70 in the housing 60. The electrical contact surface 74 of the electrical contact 66 may have a flat or slightly convex surface. The electrical contact surface 74 mates with the contact surface 40 of the electrical contact 34 as seen in FIGS. 4 and 5. Wires 76 extend from the electrical contacts 34, 66 to couple the contacts 34, 66 with a controller and an end effector (not shown). Alternatively, a receptacle can be coupled with the contacts to receive a standard industrial electrical cable.

The locking mechanism 16 includes a rotary member 80 with a handle 82 to move the locking mechanism 16 between positions. Also, the locking mechanism 16 includes latches 84 that couple with trunnions 56, 58 to lock the first member 12 and second member 14 together. The trunnions 56, 58 are positioned in recess 86 and 88 formed in the body portion 18 and latches 84, respectively.

In use, the second member extending portion 54 is positioned into the receiving bore 20 of body portion 18. The extending portion 54 continues to pass into the receiving portion 20 until the trunnions 56, 58 contact the nose 90 of the latches 84. As this occurs, due to the design of the latches 84, the latches 84 move upwards. As the latches 84 move upward, the second member 14 is continued to be pushed into the first member 12. After the trunnions 56, 58 clear the nose 90 of the latches 84, the latches 84 move downward, in response to moving the handle into its locked position, securing the trunnions 56, 58 in the latch recesses 88 as illustrated in FIG. 1. At this time, the two halves 12, 14 are locked together.

As the two halves 12, 14 are locked together, the electrical contacts 34, 66 come into electrical contact with one another. As this occurs, as illustrated in FIGS. 4 and 5, the electrical contact 66 moves into the recess in the sheath 38 adjacent electrical contact 32. As the trunnions 56, 58 are locked in place by the latches 84, the electrical connectors 30, 62 are forced against one another. As this occurs, the sheath 38 compresses and become deformed in the bore 32. The deformation of the elastomeric sheath 38 provides an opposing force so that the electrical contacts 34, 66 maintain electrical contact with one another. Thus, the resiliency of the elastomeric members provides a force to maintain contact between the contact faces 40, 74 of the electrical connectors 30, 62. Thus, springs or the like are eliminated and a simple molded construction is utilized for the electrical connectors 30, 62.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tool changer comprising:
a first member and a second member, the first member having a body with a base for securing with a robot, the body including a receiving portion to receive an extending portion of the second member, and an electrical connector on said first member body, the electrical connector including an elastomeric sheath;
the second member including a body with a mechanism for receiving an end effector, a second electrical connector on the second member body, an elastomeric sheath on the second electrical connector; and
a mechanism for locking the first and second members together such that the first electrical connector is aligned with the second electrical connector so that upon contact the sheaths deform maintaining electrical contact between the first and second electrical connectors.

2. The tool changer of claim 1, wherein the first or second electrical connector is a male contact.

3. The tool changer of claim 2, wherein the first or second electrical connector is a female contact.

4. The tool changer of claim 1, wherein the first or second electrical connector has a conical shaped portion.

5. The tool changer of claim 1, wherein a contact surface of the first or second electrical contact is flat.

6. The tool changer of claim 1, wherein a contact surface of the first or second electrical contact is convex.

7. The tool changer of claim 1, wherein the elastomeric material is polyurethane.

8. The tool changer of claim 1, wherein the first and second electrical connectors are resilient enabling compression and once a force causing the compression is removed, the first and second electrical connectors return to their original condition.

9. The tool changer of claim 1, wherein the sheaths compress generating a force in the sheaths that push the sheaths toward one another which, in turn, maintains the electrical contact between the first and second electrical contacts.
